(19) United States
(12) Patent Application Publication
(10) Pub. No.: US 2002/0154150 A1
(43) Pub. Date: Oct. 24, 2002

(54) Information processing device, and display control method and program therefor

(76) Inventors: Tadao Ogaki, Chiba (JP); Tadahiro Ohata, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/106,479

(22) Filed: Mar. 25, 2002

(30) Foreign Application Priority Data
Mar. 27, 2001 (JP) 2001-091269

(51) Int. Cl. G09G 5/00

(52) U.S. Cl. 345/684

(57) ABSTRACT

A display mode switching function unit recognizes one-click or double-click of an operating dial and switches a menu mode display image, an [H Scroll] mode display image, a [V Scroll] display image and a [Zoom] mode display image. When the [H Scroll] mode display image is displayed, an image display control function unit recognizes clockwise or counterclockwise rotation of the operating dial and causes a map image to be scrolled right or left. When the [V Scroll] mode display image is displayed, the image display control function unit recognizes clockwise or counterclockwise rotation of the operating dial and causes a map image to be scrolled up or down. When the [Zoom] mode display image is displayed, the image display control function unit recognizes clockwise or counterclockwise rotation of the operating dial and causes a map image to be displayed on an enlarged or reduced scale. Thus, display control of a displayed image is carried out without providing additional operating keys.

### BACKGROUND OF THE INVENTION

1. Field of the Invention

This invention relates to an information processing device for controlling an image displayed on a display means as an external operating means is operated, and a display control method and a program therefor.

2. Description of the Related Art

As portable information terminals among information terminals which are popularly used at present, there are portable telephones, pagers, radio receivers which support FM teletext, and PDAs (personal digital assistants). There also exist composite-type products made up of a combination of such portable information terminals. The pager, as an example of portable information terminal, is a communication tool which enables free reception and transmission of messages (via an operator) and reception of calling. The pager enables display of received information on a display means provided thereon. The pager also has two types of scroll modes, that is, a line scroll mode for scrolling the information displayed on the display means by the line, and a screen scroll mode for scrolling the information by the screen.

In the pager, the line scroll mode and the screen scroll mode are allocated to predetermined operation keys provided thereon. Thus, the user can select a desired scroll mode by operating a predetermined operation key on the pager.

Meanwhile, in the conventional pager, the number of operation keys is limited in order to realize miniaturization and thus improve the portability. Therefore, the scroll direction of the line scroll mode and the screen scroll mode is limited and only downward scroll can be made in general. However, in consideration of the user-friendliness, four scroll directions for information are desired, that is, up, down, left and right. Only the downward scroll is insufficient.

### SUMMARY OF THE INVENTION

In view of the foregoing status of the art, it is an object of the present invention to provide an information processing device capable of controlling display of information without increasing the number of operation keys, and a display control method and a program therefor.

An information processing device according to the present invention comprises: a display means for displaying an image thereon; an operating means for executing predetermined processing; a display mode switching means for switching the display mode of an image displayed on the display means in accordance with an operation to the operating means; and an image display control means for carrying out display control of the image displayed on the display means in accordance with an operation to the operating means in the display mode switched by the display mode switching means.

A display control method for an information processing device having a display means for displaying an image thereon and an operating means for executing predetermined processing, the method comprising: a display mode switching step of switching the display mode of an image displayed on the display means in accordance with an operation to the operating means; and an image display control step of carrying out display control of the image displayed on the display means in accordance with an operation to the operating means in the display mode switched at the display mode switching step.

A program according to the present invention causes an information processing device to execute processing, the information processing device having a display means for displaying an image thereon and an operating means for executing predetermined processing, the processing comprising: a display mode switching step of switching the display mode of an image displayed on the display means in accordance with an operation to the operating means; and an image display control step of carrying out display control of the image displayed on the display means in accordance with an operation to the operating means in the display mode switched at the display mode switching step.

### BRIEF DESCRIPTION OF THE DRAWINGS

FIG. 1 shows the appearance of a portable telephone, which is an example of portable information terminal as an embodiment of the present invention.

FIG. 2 shows the appearance of a PDA, which is an example of portable information terminal as the embodiment of the present invention.

FIG. 3 shows the schematic structure of an internal circuit section of the portable information terminal as the embodiment of the present invention.

FIG. 4 illustrates images displayed on a display unit of the portable information terminal as the embodiment of the present invention.

FIG. 5 is a flowchart showing the processing for controlling an image by the portable information terminal as the embodiment of the present invention.

### DESCRIPTION OF THE PREFERRED EMBODIMENTS

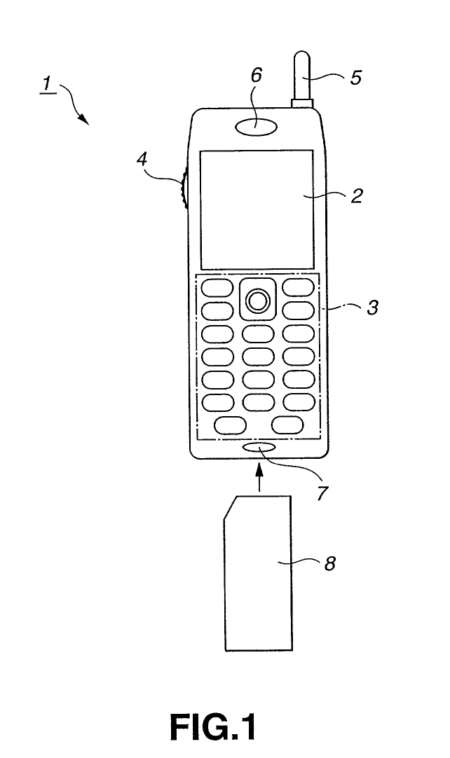

Hereinafter, a preferred embodiment of the present invention will be described in detail with reference to the drawings. In the embodiment, the present invention is applied to portable information terminals such as a portable telephone and a PDA (personal digital assistant). FIG. 1 shows the appearance of a portable telephone. A portable telephone 1 has a shape of a substantially rectangular box-like casing similar to the conventional one, and has a display unit 2, an input unit 3, a speaker 6 and a microphone 7 on its face side, and a operating dial 4 and an external antenna 5 on its lateral sides. The portable telephone 1 also can accommodate a thin plate-shaped external recording medium 8 which is freely attachable/removable, for example, a memory stick (trade name by Sony Corporation) or a memory card.

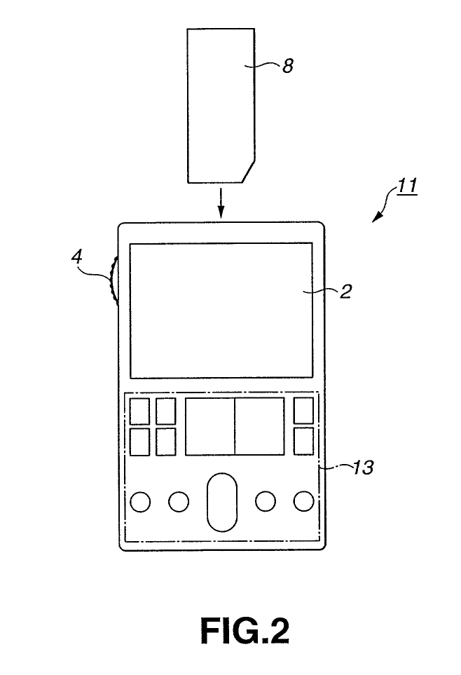

FIG. 2 shows the appearance of a PDA. A PDA 11 has a shape of a substantially rectangular box-like casing, and has a display unit 2 and an operation input unit 13 on its face side and an operating dial 4 on its lateral side. The PDA 11 also can accommodate a thin plate-shaped external recording medium 8 which is freely attachable/removable, similarly to the portable telephone 1.

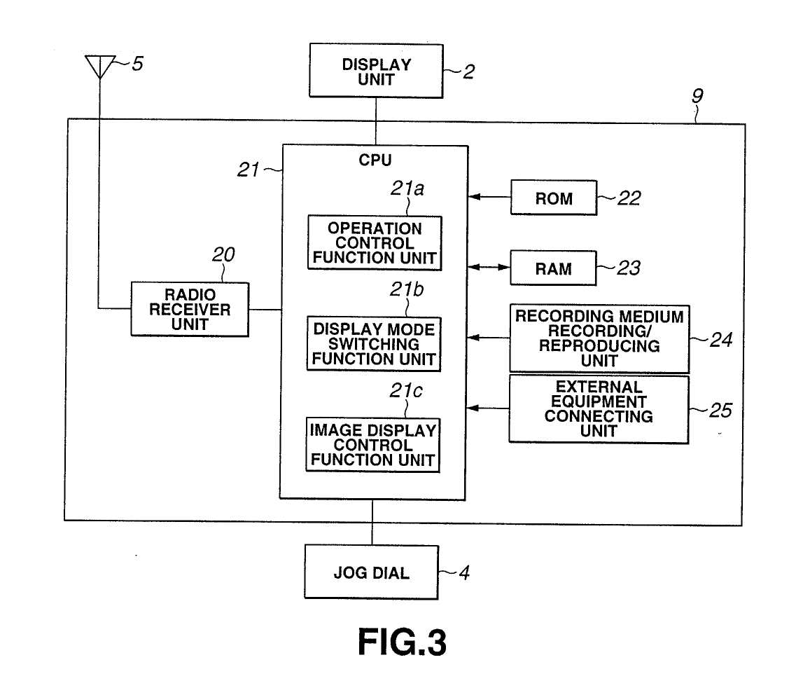

The schematic structure of an internal circuit section 9 which is common to the above-described portable telephone 1 and PDA 11 will now be described with reference to FIG. 3. The internal circuit section 9 shown in FIG. 3 includes at least a radio receiver unit 20, a CPU (central processing unit)21, a ROM (read only memory) 22, a RAM (random access memory) 23, a recording medium recording/reproducing unit 24, and an external equipment connecting unit 25.

Functional blocks representing the functions to be executed by the CPU 21 may include an operation control function unit 21a for controlling the operations of the respective units executed by various programs, a display mode switching function unit 21b as a display mode switching means for switching the display mode of an image displayed on the display unit 2, and an image display control function unit 21c as an image display control means for carrying out display control of an image displayed on the display unit 2 as the operating dial 4 is rotated.

The functions of the respective units will now be described. The display unit 2 is, for example, an LCD (liquid crystal display), on which information is displayed as an image. The operating dial 4 is a conventionally used disc-shaped operating means and has a function to select predetermined information by a rotating operation and a function to decide predetermined information by a press or push operation (hereinafter referred to as click).

The radio receiver unit 20 receives information transmitted from a source station via the antenna 5. The RAM 23 is an area used for storage and expansion of information. The information received by the radio receiver unit 20 or the like is stored in this RAM 23. The recording medium recording/reproducing unit 24 reproduces information recorded on the thin plate-shaped recording medium 8 loaded on a loading part, not shown, provided in the recording medium recording/reproducing unit 24. The external equipment connecting unit 25 is connected with an external equipment. In the ROM 22, programs for controlling the operations of the respective units are stored. The operation control function unit 21a executes various programs stored in the ROM 22 and thus controls the operations of the respective units. For example, the operation control function unit 21a instantly processes information transmitted from the source station and displays the processed information as an image on the display unit 2. The operation control function unit 21a also receives from the source station all the necessary information for executing scroll and zooming of an image, which will be described later, then stores the information to the RAM 23, and displays the information stored in the RAM 23 onto the display unit 2 as an image. The operation control function unit 21a also displays the information recorded on the thin plage-shaped external recording medium 8 loaded in the recording medium recording/reproducing unit 24 or the information recorded in the external equipment connected to the external equipment connecting unit 25, onto the display unit 2 as an image.

The display mode switching function unit 21b switches the display mode of an image displayed on the display unit 2 in accordance with clicking of the operating dial 4. When the display mode resulting from switching by the display mode switching function unit 21b is a scroll mode, the image display control function unit 21c scrolls the image displayed on the display unit 2 in accordance with a rotating operation of the operating dial 4. When the display mode resulting from switching by the display mode switching function unit 21b is a zooming mode, the image display control function unit 21c changes the display scale of the image displayed on the display unit 2 in accordance with a rotating operation of the operating dial 4.

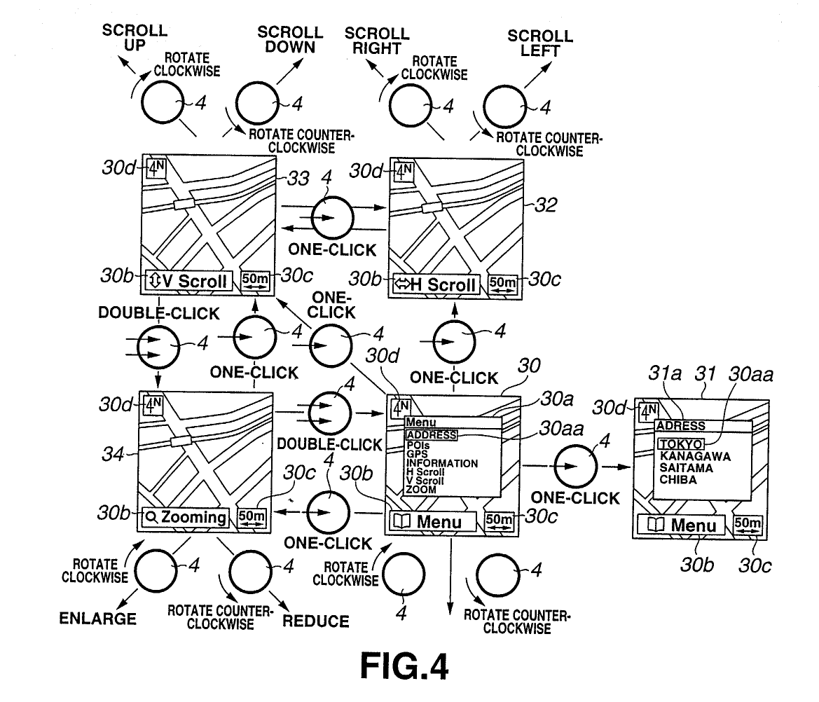

FIG. 4 shows images displayed on the display unit 2 by the portable information terminal, constituted as described above, in accordance with an operation to the operating dial 4. It is assumed that an initial image displayed on the display unit 2 is a map image. If the operating dial 4 is clicked once (hereinafter referred to as one-click) when this map image is displayed, a menu mode display image 30 will be displayed. In this menu mode display image 30, a display mode title list 30a, a display mode 30b indicating the current display mode, a scale 30c and a direction 30d are displayed on the map image.

The display mode title list 30a shows a list of a plurality of display mode titles and is placed near the center of the menu mode display image 30. The display mode 30b contains the name of the current display mode and an icon which enables visual recognition of the display mode name, and is placed at a lower left part of the menu mode display image 30. In the menu mode display image 30, “Menu” is displayed as the display mode name and an icon in the form of a spread book is displayed. The scale 30c contains a line with arrows indicating a reference distance and the numerical value of the reference distance, and is placed at a lower right part of the menu mode display image 30. The direction 30d is placed at an upper left part of the menu mode display image 30. These display mode 30b, scale 30c and direction 30d are also contained in an [H Scroll] mode display image 32, a [V Scroll] mode display image 33 and a [Zoom] mode display image 34, which will be described later, and are placed at the same positions.

If the operating dial 4 is rotated when the menu mode display image 30 is displayed, a selection bar 30aa will shift which is selecting a predetermined display mode title in the display mode title list 30a. Then, if the operating dial 4 is one-clicked, the selected display mode title will be decided and that display mode will be started. With respect to the shift of the selection bar 30aa, if the operating dial 4 is rotated clockwise, the selection bar 30aa will shift upward along a plurality of display mode titles forming an array. On the contrary, if the operating dial 4 is rotated counterclockwise, the selection bar 30aa will shift downward along a plurality of display mode titles forming an array. Moreover, in the display mode title list 30a, a plurality of display mode titles are displayed such as [H Scroll] (horizontal or left-and-right scroll), [V Scroll] (vertical or up-and-down scroll), [Zoom] (enlargement/reduction), [Address] (place name-map access), [POIs] (point-map access), [GPS] (current position-map access), and [Information] (information display).

If the operating dial 4 is one-clicked when [Address] is selected in the menu mode display image 30, a place name display image 31 will be displayed. In this place name display image 31, a place name list 31a, the display mode 30b, the scale 30c and the direction 30d are displayed. The place name list 31a shows a list of a plurality of place names and is placed near the center of the place name display image 31. The user can shift the selection bar 30aa within the place name list 31a and thus can select and decide a desired place name.

If the operating dial 4 is one-clicked when [H Scroll] is selected in the menu mode display image 30, an [H Scroll] mode display image 32 will be displayed. If the operating dial 4 is one-clicked when [V Scroll] is selected, a [V Scroll] mode display image 33 will be displayed. If the operating dial 4 is one-clicked when [Zoom] is selected, a [Zoom] mode display image 34 will be displayed.

To switch these menu mode display image 30, [H Scroll] mode display image 32, [V Scroll] mode display image 33 and [Zoom] mode display image 34, clicking of the operating dial 4 is used. Specifically, if the operating dial 4 is one-clicked when the [H Scroll] mode display image 32 is displayed, the [V Scroll] mode display image 33 will be displayed. On the contrary, if the operating dial 4 is one-clicked when the [V Scroll] mode display image 33 is displayed, the [H Scroll] mode display image 32 will be displayed.

Moreover, if the operating dial 4 is quickly clicked twice (hereinafter referred to as double-click) when the [V Scroll] mode display image 33 is displayed, the [Zoom] mode display image 34 will be displayed. On the contrary, if the operating dial 4 is one-clicked when the [Zoom] mode display image 34 is displayed, [V Scroll] mode display image 33 will be displayed. If the operating dial 4 is double-clicked when the [Zoom] mode display image 34 is displayed, the menu mode display image 30 will be displayed.

In these [H Scroll] mode display image 32, [V Scroll] mode display image 33 and [Zoom] mode display image 34, the display mode 30b, the scale 30c and the direction 30d are displayed on the map image as described above. The display mode 30b on the [H Scroll] mode display image 32 contains a display mode name “H Scroll” and an icon in the form of a bold arrow in the left-and-right direction. The display mode 30b on the [V Scroll] mode display image 33 contains a display mode name “V Scroll” and an icon in the form of a bold arrow in the up-and-down direction. The display mode 30b on the [Zoom] mode display image 34 contains a display mode “Zooming” and an icon in the form of a magnifying glass. With respect to the scale 30c on the [Zoom] mode display image 34, the numerical value of the reference distance is changed in accordance with enlargement or reduction of the map image.

In the [H Scroll] mode display image 32, the [V Scroll] mode display image 33 and the [Zoom] mode display image 34, the display of the map image is controlled by rotating the operating dial 4. Specifically, if the operating dial 4 is rotated clockwise when the [H Scroll] mode display image 32 is displayed, the map image will be scrolled right. If the operating dial 4 is rotated counterclockwise, the map image will be scrolled left. If the operating dial 4 is rotated clockwise when the [V Scroll] mode display image 33 is displayed, the map image will be scrolled up. If the operating dial 4 is rotated counterclockwise, the map image will be scrolled down. In this manner, two-dimensional scroll is made by the one-dimensional operation of the operating dial 4. Moreover, if the operating dial 4 is rotated clockwise when the [Zoom] mode display image 34 is displayed, the map image will be enlarged (narrowed). If the operating dial 4 is rotated counterclockwise, the map image will be reduced (widened).

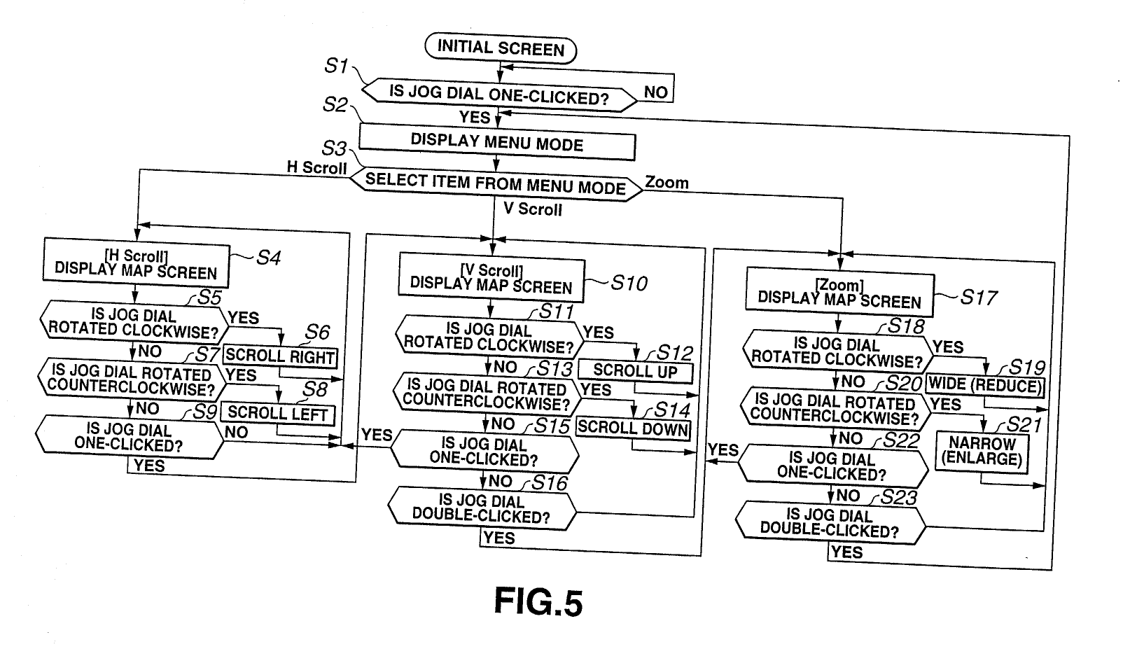

The processing for switching the plurality of images displayed as described above and the processing for controlling the images, by the internal circuit section 9 of the portable information terminal, will now be described with reference to the flowchart of FIG. 5. At step S1, if the display mode switching function unit 21b recognized one-click of the operating dial 4 when a map image was displayed on the display unit 2 (YES), the processing goes to step S2. At step S2, the display mode switching function unit 21b causes the display unit 2 to display the menu mode display image 30 thereon. The display mode title list 30a in the menu mode display image 30 contains [H Scroll], [V Scroll], [Zoom], [Address], [POIs], [GPS], [Information] and the like, as described above.

On the other hand, if the display mode switching function unit 21b did not recognize one-click of the operating dial 4 when a map image was displayed on the display unit 2 (NO), the portable information terminal is in the standby state.

At step S3, if the display mode switching function unit 21b recognized one-click of the operating dial 4 when [H Scroll] was selected by a rotating operation of the operating dial 4, the processing goes to step S4. Meanwhile, if the display mode switching function unit 21b recognized one-click of the operating dial 4 when [V Scroll] was selected by a rotating operation of the operating dial 4, the processing goes to step S10. If the display mode switching function unit 21b recognized one-click of the operating dial 4 when [Zoom] is selected by a rotating operation of the operating dial 4, the processing goes to step S17.

In this manner, the display mode switching function unit 21b switches the menu mode display image 30 to a predetermined display mode in accordance with the operation of the operating dial 4 at step S3. Hereinafter, the processing after the display mode switching function unit 21b recognizes one-click of the operating dial 4 when [H Scroll], [V Scroll] or [Zoom] is selected will be described, respectively.

First, at step S4, the display mode switching function unit 21b causes the display unit 2 to display the [H Scroll] mode display image 32 thereon. Then, at step S5 and step S7, the image display control function unit 21c recognizes whether the operating dial 4 is rotated clockwise or counterclockwise. If the display image control function unit 21c recognizes clockwise rotation of the operating dial 4 (YES) at step S5, the image display control function unit 21c at step S6 causes the map image to be scrolled right in accordance with the rotation of the operating dial 4.

On the other hand, if the image display control function unit 21c did not recognize clockwise rotation of the operating dial 4 (NO) at step S5 and recognized counterclockwise rotation of the operating dial 4 (YES) at step S7, the image display control function unit 21c at step S8 causes the map image to be scrolled left in accordance with rotation of the operating dial 4.

If the image display control function unit 21c did not recognize counterclockwise rotation of the operating dial 4 (NO) at step S7, that is, if the operating dial 4 was not rotated in either direction, the processing goes to step S9. If the display mode switching function unit 21b did not recognize one-click of the operating dial 4 (NO) at step S9, the processing returns to the above-described step S4 and the display of the [H Scroll] mode display image 32 on the display unit 2 is continued.

Meanwhile, if the display mode switching function unit 21b recognized one-click of the operating dial 4 (YES) at step S9, the display mode switching function unit 21b at step S10 switches the display mode and causes the display unit 2 to display the [V Scroll] mode display image 33 thereon. The other processing for displaying the [V Scroll] mode display image 33 is carried out if the display mode switching function unit 21b recognized one-click of the operating dial 4 when [V Scroll] was selected in the display mode title list 30a in the menu mode display image 30, as described above with respect to step S3.

Then, at step S11 and step S13, the image display control function unit 21c recognizes whether the operating dial 4 is rotated clockwise or counterclockwise. If the image display control function unit 21c recognized clockwise rotation of the operating dial 4 (YES) at step S11, the image display control function unit 21c at step S12 causes the map image to be scrolled up in accordance with the rotation of the operating dial 4.

On the other hand, if the image display control function unit 21c did not recognize clockwise rotation of the operating dial 4 (NO) at step S11 and recognized counterclockwise rotation of the operating dial 4 (YES) at step S13, the image display control function unit 21c at step S14 causes the map image to be scrolled down in accordance with the rotation of the operating dial 4.

If the image display control function unit 21c did not recognize counterclockwise rotation of the operating dial 4 (NO) at step S13, that is, if the operating dial 4 was not rotated in either direction, the processing goes to step S15.

Then, at step S15 and step S16, the display mode switching function unit 21b recognizes whether operating dial 4 is one-clicked or double-clicked. If the display mode switching function unit 21b recognized one-click of the operating dial (YES) at step S15, the processing returns to the above-described step S4 and the display mode switching function unit 21b switches the display mode and causes the display unit 2 to display the [H Scroll] mode display image 32 thereon.

On the other hand, if the display mode switching function unit 21b did not recognize one-click of the operating dial 4 (NO) at step S15 and recognized double-click of the operating dial 4 (YES) at step S16, the display mode switching function unit 21b at step S17 switches the display mode and causes the display unit 2 to display the [Zoom] mode display image 34 thereon. The other processing for displaying the [Zoom] mode display image 34 is carried out if the display mode switching function unit 21b recognized one-click of the operating dial 4 when [Zoom] was selected in the display mode title list 30a in the menu mode display image 30, as described above with respect to step S3.

If the display mode switching function unit 21b did not recognize double-click of the operating dial 4 (NO) at step S16, that is, if the operating dial 4 was not clicked at all, the processing returns to the above-described step S10 and the display of the [V Scroll] mode display image 33 on the display unit 2 is continued.

After the [Zoom] mode display image 34 is displayed at step S17, the image display control function unit 21c recognizes whether the operating dial 4 is rotated clockwise or counterclockwise, at step S18 and step S20. If the image display control function unit 21c recognized clockwise rotation of the operating dial 4 (YES) at step S18, the image display control function unit 21c at step S19 causes the map image to be displayed on a reduced scale in accordance with the rotation of the operating dial 4.

On the other hand, if the image display control function unit 21c did not recognize clockwise rotation of the operating dial 4 (NO) at step S18 and recognized counterclockwise rotation of the operating dial 4 (YES) at step S20, the image display control function unit 21c at step S21 causes the map image to be displayed on an enlarged scale in accordance with the rotation of the operating dial 4.

If the image display control function unit 21c did not recognize counterclockwise rotation of the operating dial 4 (NO) at step S20, that is, if the operating dial 4 was not rotated in either direction, the processing goes to step S22.

Then, at step S22 and step S23, the display mode switching function unit 21b recognizes whether the operating dial 4 is one-clicked or double-clicked. If the display mode switching function unit 21b recognized one-click of the operating dial 4 (YES) at step S22, the processing returns to the above-described step S10 and the display mode switching function unit 21b switches the display mode and causes the display unit 2 to display the [V Scroll] mode display image 33 thereon.

On the other hand, if the display mode switching function unit 21b did not recognize one-click of the operating dial 4 (NO) at step S22 and recognized double-click of the operating dial 4 (YES) at step S23, the display mode switching function unit 21b switches the display mode and causes the display unit 2 to display the menu mode display image 30, similarly to the above-described step S2.

If the display mode switching function unit 21b did not recognize double-click of the operating dial 4 (NO) at step S23, that is, if the operating dial 4 was not clicked at all, the processing returns to the above-described step S17 and the display of the [Zoom] mode display image 34 on the display unit 2 is continued.

The processing for switching the menu mode display image 30, the [H Scroll] mode display image 32, the [V Scroll] mode display image 33 and the [Zoom] mode display image 34 and the processing for controlling the respective images by the internal circuit section 9 are described above in detail. The display modes [Address], [POIs], [GPS] and [Information] listed in the above-described display mode title list 30a will now be described. The user can acquire a map image showing an area near a certain place name, a certain point, or the current position, by using these display modes.

First, if the display mode switching function unit 21b recognized one-click of the operating dial 4 when [Address] was selected, the display mode switching function unit 21b causes the display unit 2 to display a place name list thereon. Moreover, if the display mode switching function unit 21b recognized one-click of the operating dial 4 when a predetermined place name was selected in the place name list, the display mode switching function unit 21b causes the display unit 2 to display a map image of an area near that place name.

If the display mode switching function unit 21b recognized one-click of the operating dial 4 when [POIs] was selected, the display mode switching function unit 21b causes the display unit 2 to display a point (landmark) list thereon. Moreover, if the display mode switching function unit 21b recognized one-click of the operating dial 4 when a predetermined point was selected in the point list, the display mode switching function unit 21b causes the display unit 2 to display a map image of an area near that point.

If the display mode switching function unit 21b recognized one-click of the operating dial 4 when [GPS] was selected, the display mode switching function unit 21b causes the display unit 2 to display a map image of an area near the current position calculated by using the GPS (Global Positioning System).

If the display mode switching function unit 21b recognized one-click of the operating dial 4 when [Information] was selected, the display mode switching function unit 21b causes the display unit 2 to display the place name or point information of a point near the center of the map image.

As described above in detail, in the portable information terminal according to the embodiment of the present invention, the display mode switching function unit 21b switches the display mode of the map image when it recognized clicking of the operating dial 4. Moreover, if the switched display mode is the [H Scroll] mode, the image display control function unit 21c scrolls the map image leftward or rightward when it recognized rotation of the operating dial 4. If the switched display mode is the [V Scroll] mode, the image display control function unit 21c scrolls the map image upward and downward when it recognized rotation of the operating dial 4. If the switched display mode is the [Zoom] mode, the image display control function unit 21c caused the map image to be displayed on an enlarged or reduced scale when it recognized rotation of the operating dial 4. Thus, the user can easily switch the [H Scroll] mode, the [V Scroll] mode and the [Zoom] mode, simply by clicking the operating dial 4 provided on the portable information terminal. Moreover, the user can easily scroll the map image in the [H Scroll] mode and the [V Scroll] mode and enlarge or reduce the display of the map image in the [Zoom] mode, simply by rotating the operating dial 4.

While a map image is set as an initial image in the above-described embodiment, the present invention is not limited to this and, for example, a weather chart that can be seen as a text may be employed as an initial image. While the display mode switching function unit 21b switches the [V Scroll] mode display image 33 and the [Zoom] mode display image 34 in the above-described embodiment, for example, switching between the [H Scroll] mode display image 32 and the [Zoom] mode display image 34 can be easily realized.

As described above in detail, in the information processing device according to the present invention, the display mode switching means switches the display mode of an image displayed on the display means in accordance with an operation to the operating means. The image display control means carries out display control of the image displayed on the display means in accordance with an operation to the operating means in the switched display mode. Thus, the user can easily switch the display mode simply by operating the operating means provided on the information processing device. Moreover, the user can control the display image in accordance with the display mode simply by operating the operating means.

In the display control method for the information processing device according to the present invention, at the display mode switching step, the display mode of an image displayed on the display means is switched in accordance with an operation to the operating means. At the image display control step, display control of the image displayed on the display means is carried out in accordance with an operation to the operating means in the switched display mode. Thus, the user can easily switch the display mode simply by operating the operating means provided on the information processing device. Moreover, the user can control the display image in accordance with the display mode simply by operating the operating means.

In the program according to the present invention, at the display mode switching step, the display mode of an image displayed on the display means is switched in accordance with an operation to the operating means. At the image display control step, display control of the image displayed on the display means is carried out in accordance with an operation to the operating means in the switched display mode. Thus, the user can easily switch the display mode simply by operating the operating means provided on the information processing device. Moreover, the user can control the display image in accordance with the display mode simply by operating the operating means.

What is claimed is:

1. An information processing device comprising:
a display means for displaying an image thereon;
an operating means for executing predetermined processing;
a display mode switching means for switching the display mode of an image displayed on the display means in accordance with an operation to the operating means; and
an image display control means for carrying out display control of the image displayed on the display means in accordance with an operation to the operating means in the display mode switched by the display mode switching means.

2. The information processing device as claimed in claim 1, wherein when the display mode of the image displayed on the display means is a scroll mode, the display mode switching means switches the display mode to one of a plurality of scroll modes having scroll directions intersecting each other, in accordance with an operation to the operating means.

3. The information processing device as claimed in claim 1, wherein the display mode switching means switches the display mode between a scroll mode, which is one of display modes, and a zooming mode, which is one of display modes, in accordance with an operation to the operating means.

4. The information processing device as claimed in claim 1, wherein the display mode switching means switches the display mode to a menu mode, which is one of display modes, in accordance with an operation to the operating means.

5. The information processing device as claimed in claim 1, wherein the operating means is an operating dial as an input device for carrying out rotating and pressing operations.

6. The information processing device as claimed in claim 5, wherein when the display mode of the image displayed on the display means is a scroll mode, the display mode switching means switches the display mode to a scroll mode having a scroll direction intersecting that of the previous scroll mode, in accordance with an operating to press the operating dial once.

7. The information processing device as claimed in claim 5, wherein when the display mode of the image displayed on the display means is a scroll mode, the display mode switching means switches the display mode to a zooming mode, which is one of display modes, in accordance with an operation to quickly press the operating dial twice.

8. The information processing device as claimed in claim 5, wherein when the display mode of the image displayed on the display means is a scroll mode, the image display control means causes the image displayed on the display means to be scrolled in accordance with a rotating operation of the operating dial.

9. The information processing device as claimed in claim 5, wherein when the display mode of the image displayed on the display means is a zooming mode, the display mode switching means switches the display mode to a scroll mode in accordance with an operation to press the operating dial once.

10. The information processing device as claimed in claim 5, wherein when the display mode of the image displayed on the display means is a zooming mode, the image display control means changes the display scale of the image displayed on the display means in accordance with a rotating operation of the operating dial.

11. The information processing device as claimed in claim 1, wherein the image displayed on the display means is a map image.

12. The information processing device as claimed in claim 11, comprising a receiving means for receiving information transmitted from a source station, wherein the map image is displayed on the basis of the information received by the receiving means.

13. The information processing device as claimed in claim 11, comprising a recording means for recording information, wherein the map image is displayed on the basis of the information recorded on the recording means.

14. The information processing device as claimed in claim 11, comprising a recording medium connecting means for connecting an external recording medium, wherein the map image is displayed on the basis of information recorded on the external recording medium connected to the recording medium connecting means.

15. The information processing device as claimed in claim 11, comprising an external equipment connecting means for connecting an external equipment, wherein the map image is displayed on the basis of information recorded in the external equipment connected to the external equipment connecting means.

16. A display control method for an information processing device having a display means for displaying an image thereon and an operating means for executing predetermined processing, the method comprising:
a display mode switching step of switching the display mode of an image displayed on the display means in accordance with an operation to the operating means; and
an image display control step of carrying out display control of the image displayed on the display means in accordance with an operation to the operating means in the display mode switched at the display mode switching step.

17. The display control method as claimed in claim 16, wherein when the display mode of the image displayed on the display means is a scroll mode, at the display mode switching step, the display mode is switched to one of a plurality of scroll modes having scroll directions intersecting each other, in accordance with an operation to the operating means.

18. The display control method as claimed in claim 16, wherein at the display mode switching step, the display mode is switched between a scroll mode, which is one of display modes, and a zooming mode, which is one of display modes, in accordance with an operation to the operating means.

19. The display control method as claimed in claim 16, wherein at the display mode switching step, the display mode is switched to a menu mode, which is one of display modes, in accordance with an operation to the operating means.

20. The display control method as claimed in claim 16, wherein the operating means is an operating dial as an input device for carrying out rotating and pressing operations.

21. The display control method as claimed in claim 20, wherein when the display mode of the image displayed on the display means is a scroll mode, at the display mode switching step, the display mode is switched to a scroll mode having a scroll direction intersecting that of the previous scroll mode, in accordance with an operating to press the operating dial once.

22. The display control method as claimed in claim 20, wherein when the display mode of the image displayed on the display means is a scroll mode, at the display mode switching step, the display mode is switched to a zooming mode, which is one of display modes, in accordance with an operation to quickly press the operating dial twice.

23. The display control method as claimed in claim 20, wherein when the display mode of the image displayed on the display means is a scroll mode, at the image display control step, the image displayed on the display means is scrolled in accordance with a rotating operation of the operating dial.

24. The display control method as claimed in claim 20, wherein when the display mode of the image displayed on the display means is a zooming mode, at the display mode switching step, the display mode is switched to a scroll mode in accordance with an operation to press the operating dial once.

25. The display control method as claimed in claim 20, wherein when the display mode of the image displayed on the display means is a zooming mode, at the image display control step, the display scale of the image displayed on the display means is changed in accordance with a rotating operation of the operating dial.

26. The display control method as claimed in claim 16, wherein the image displayed on the display means is a map image.

27. The display control method as claimed in claim 26, wherein the map image is displayed on the basis of information transmitted from a source station.

28. The display control method as claimed in claim 26, wherein the map image is displayed on the basis of information recorded on a recording means.

29. The display control method as claimed in claim 26, wherein the map image is displayed on the basis of information recorded on an external recording medium.

30. The display control method as claimed in claim 26, wherein the map image is displayed on the basis of information recorded in an external equipment that can be connected.

31. A program for causing an information processing device to execute processing, the information processing device having a display means for displaying an image thereon and an operating means for executing predetermined processing, the processing comprising:
a display mode switching step of switching the display mode of an image displayed on the display means in accordance with an operation to the operating means; and
an image display control step of carrying out display control of the image displayed on the display means in accordance with an operation to the operating means in the display mode switched at the display mode switching step.
